(19) United States
(12) Patent Application Publication
(10) Pub. No.: US 2011/0157032 A1
(43) Pub. Date: Jun. 30, 2011

(54) Writing Apparatus with Electronic Soft Pen Brush

(75) Inventors: Chung-Fuu Mao, Hsin-Chu (TW); Chia-Jui Yeh, Taipei (TW)

(73) Assignee: WALTOP INTERNATIONAL CORPORATION, Hsinchu (TW)

(21) Appl. No.: 12/725,325

(22) Filed: Mar. 16, 2010

(30) Foreign Application Priority Data
Dec. 28, 2009 (TW) 098145402

(51) Int. Cl. G06F 3/041; G06F 3/033

(52) U.S. Cl. 345/173; 345/179

(57) ABSTRACT

A writing apparatus with electronic soft brush pen is disclosed herein. The writing apparatus includes an electronic soft pen brush, an all point addressable (APA) touch panel, a scanning circuit and a controlling circuit. The electronic soft pen brush is configured to generate a plurality of touch points on the touch panel simultaneously. The scanning circuit is configured to detect the touch positions of the touch points simultaneously. The controlling circuit is configured to determine the touch region, the touch area and size and generate an output signal in accordance with the touch region, the touch area and the touch positions.

### BACKGROUND OF THE INVENTION

1. Field of the Invention

The present invention is related to a writing apparatus, and more particularly related to a writing apparatus with electronic soft pen brush.

2. Description of the Prior Art

Because the progress of science and technology is so fast, the touch device can help the customer to be familiar with this electronic device in a very short time so as to reduce the manipulate difficulty of the electronic device. Because of the advantage of the user friendly of the touch device, most of the electronic device will include touch function to be one of the main features, such as touch TV, touch computer, touch smart phone and so on.

However, most of the touch techniques are implemented to determine the touch points by detecting the voltage change or the illuminant change in the positions of the touch pen or human fingers, and only configured to detect the coordinate of the touch point. When the user would like to simulate the script of Chinese calligraphy brush or Gouache brush on the touch panel, the user has to touch the touch panel several times with different strength (as the touch pen disclosed in U.S. Pat. No. 5,134,689) to represent different sizes of circles and those touch positions are calculated by a drawing application software so as to show different types of scripts similar to the conventional Chinese calligraphy brush or Gouache brush. In addition, the user is required to practice a hand writing skill different to the conventional Chinese Calligraphic writing skill on the touch panel to show a similar writing result as using a Chinese calligraphy brush or Gouache brush on a conventional paper, but there is still a little different writing skill compared to the regular hand writing. FIG. 1A is a diagram illustrating that the conventional single touch and FIG. 1B is a diagram illustrating that the conventional multi touches. As shown in FIG. 1A and FIG. 1B, either single touch technique or multi touches technique is used, the touch device would detect the touch points as different sizes of circles. In other word, if the user would like to implement this touch technique as Calligraphy or Panting, a software is required to transform those circles to the conventional Chinese calligraphy brush or Gouache brush.

Therefore, according to the touch technique describe above, a need has arisen to design a device to scan the touch shape, size and region on the touch panel and transmit the touch region of the touch points directly to a computer without complicated software procedure to simulate the touch points.

### SUMMARY OF THE INVENTION

According to the prior art described above, one object of the present invention is to provide a writing apparatus with electronic soft pen brush as an input device for the user to draw or handwriting.

Another object of the present invention is to provide a writing apparatus without software to transform different touch points to be calligraphy.

According the objects described above, a writing apparatus with electronic soft pen brush is disclosed herein and includes an electronic soft pen brush, a touch panel, a scanning circuit and a controlling circuit. The touch panel is configured to generate a plurality of touch points when the electronic soft pen brush touches the touch panel. The scanning circuit is configured to detect a plurality of touch position of the touch points simultaneously. The controlling circuit is configured to determine a touch region of the touch points in accordance with the touch positions of the touch points, and transform the touch region and the touch positions to an output signal.

A writing apparatus with electronic soft pen brush is also disclosed herein and includes an electronic soft pen brush, a touch panel, a scanning circuit and a controlling circuit. The electronic soft pen brush includes a pen-nib. The touch panel is configured to generate a plurality of touch points when the electronic soft pen brush touches the touch panel. The scanning circuit is configured to detect a plurality of touch position of the touch points simultaneously. The controlling circuit is configured to determine a touch region of the touch points in accordance with the touch positions of the touch points, and transform the touch region and the touch positions to an output signal. The writing apparatus generates a plurality of the touch regions with different sizes in accordance with touch angle and touch strength used by the pen-nib on the touch panel.

An electronic device with a writing apparatus is also disclosed herein and includes a writing apparatus and a display. The writing apparatus includes an electronic soft pen brush, a touch panel, a scanning circuit and a controlling circuit. The electronic soft pen brush includes a pen-nib. The touch panel is configured to generate a plurality of touch points when the electronic soft pen brush touches the touch panel. The scanning circuit is configured to detect a plurality of touch position of the touch points simultaneously. The controlling circuit is configured to determine a touch region of the touch points in accordance with the touch positions of the touch points, and transform the touch region and the touch positions to an output signal. The display is configured to present the touch region and the touch positions on the display. The writing apparatus generates a plurality of the touch regions with different sizes in accordance with touch angle and touch strength used by the pen-nib on the touch panel.

### BRIEF DESCRIPTION OF THE DRAWINGS

FIG. 1A is a diagram illustrating that the conventional single touch;

FIG. 1B is a diagram illustrating that the conventional multi touches;

FIG. 2 is a block diagram illustrating that a writing apparatus in the present invention; and

FIG. 3A and FIG. 3B are diagrams illustrating that the touch region shown on the touch panel.

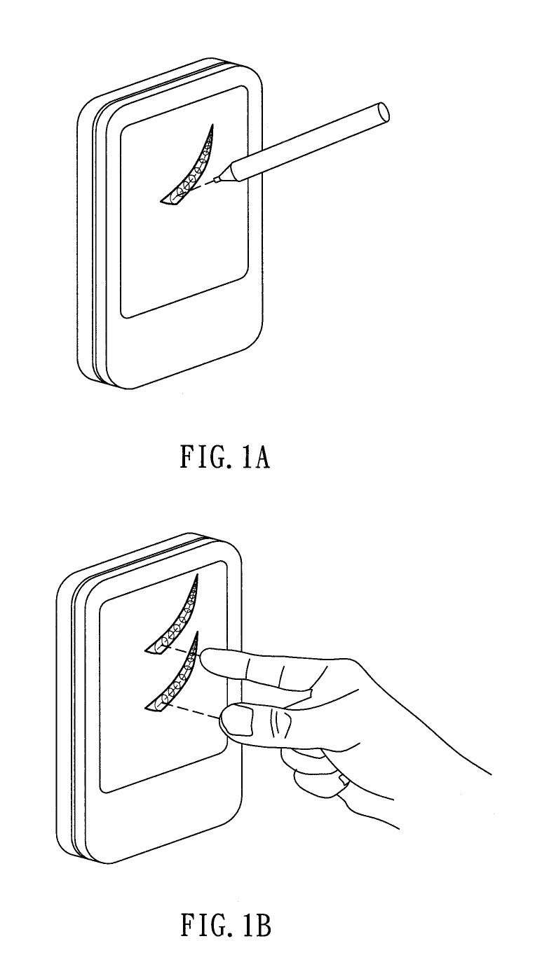

### DESCRIPTION OF THE PREFERRED EMBODIMENT

The foregoing aspects and many of the attendant advantages of this invention will become more readily appreciated as the same becomes better understood by reference to the following detailed description, when taken in conjunction with the accompanying drawings, wherein:

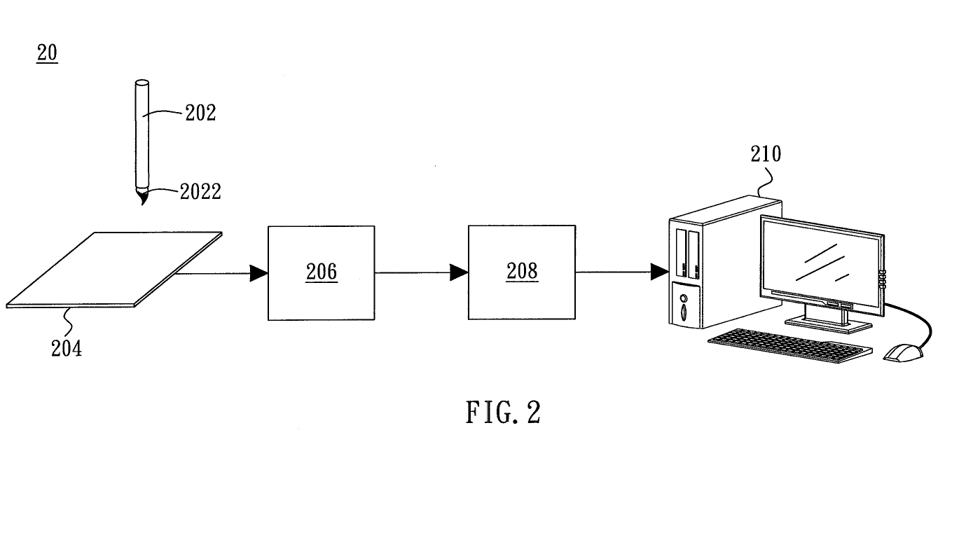

FIG. 2 is a block diagram illustrating a writing apparatus in the present invention. As shown in FIG. 2, the writing apparatus 20 includes an electronic soft pen brush 202, a touch panel 204, a scanning circuit 206 and a controlling circuit 208. The electronic soft pen brush 202 of the writing apparatus 20 is different to the conventional stylus pen, and the pen-nib 2022 of the electronic soft pen brush 202 is a soft brush or a soft nib like Chinese calligraphy brush or Gouache brush. The material of the pen-nib 2022 is made by soft plastic, elastic paper fiber, thermoplastic elastomer (TPE), thermoplastic rubber (TPR), woolens and so on. The touch panel 204 is a capacitance touch panel, an optical touch panel or an improved resistance touch panel. The touch panel, which is able to perform all point addressable (APA) touch technique, is the touch panel 202 used in the present invention. The scanning circuit 206 is configured to detect all the touch points (the touch area, the touch shape and the touch position) of the electronic soft pen brush at the same time in the touch panel 204. The controlling circuit 208 will transform all the touch points detected by the scanning circuit 206 to be electronic signal to the processor or calculator in an electronic device 210 (such as electronic portable device and so on) and the touch region will show on the screen of the electronic device 210.

Still referring to FIG. 2, when the user uses the electronic soft pen brush 202 to write or paint on the touch panel 204, the touch region of the electronic soft pen brush 202 is no longer determined as one touch point. The scanning circuit 208 of the writing apparatus in the present invention will record the touch shape, the touch area, and the touch coordinate of the electronic soft pen brush 202 on the touch panel 204. In other word, the script of the writing of the user will be completely determined by the scanning circuit 206 and is different to the conventional touch panel, which is only determining all touch points as different sizes of circles. The scanning circuit 206 determines the touch positions and the touch region of the electronic soft pen brush 202 according to the voltage variation (such as capacitance touch panel) or the illuminant reflective variation (such as optical touch panel). The controlling circuit 208 will transform all the touch points detected by the scanning circuit 206 to be electronic signal to the processor or calculator in an electronic device 210 and the touch region will show on the screen of the electronic device 210.

In addition, it should be noted that the touch panel 204 in the present invention is an all point addressable (APA) touch panel. The APA touch panel can be a capacitance touch panel, an infrared ray touch panel, an improved resistance touch panel or an optical touch panel. The touch panel which is able to perform APA touch is related to the touch panel 202 in the present invention. For example, the improved resistance touch panel utilizes Independent-matrix sense elements, which include Intersection-matrix of row and column sense elements and intersection matrix made by two respectively isolated horizon (row) and vertical (column) conductive layers, to perform APA touch technique on the touch panel. The optical touch panel is configured to determine the touch region, the touch shape and the touch position of the electronic soft pen brush 202 on the touch panel 204 by an image device (such as digital camera) so as to achieve the APA touch technique.

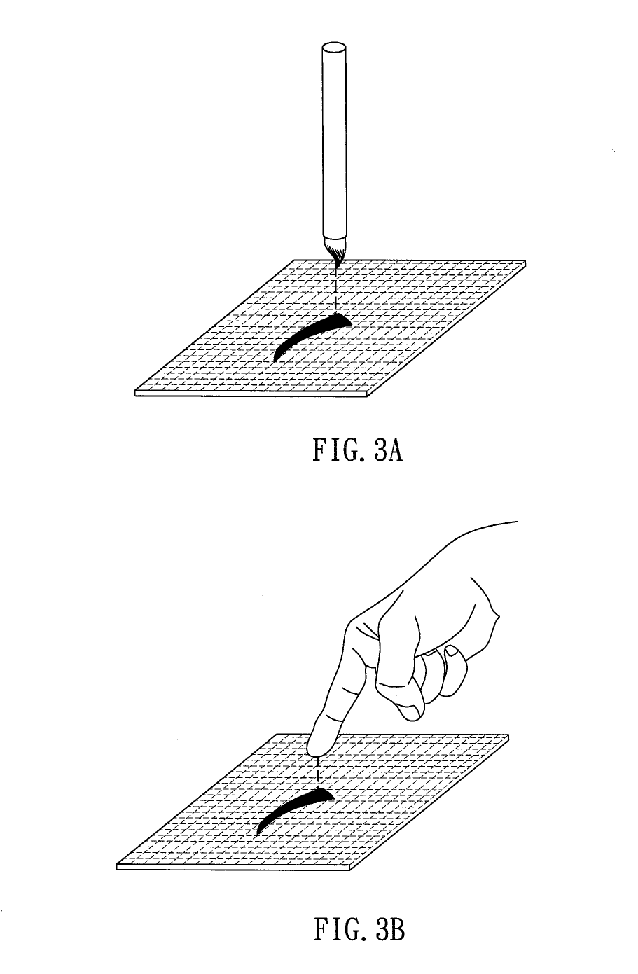

FIG. 3A and FIG. 3B are diagrams illustrating that the touch region shown on the touch panel. As shown in FIG. 3A, because the electronic soft pen brush of the writing apparatus in the present invention is a soft pen, the soft pen is able to generate several different types of touch region, touch shape, touch area, touch size or touch position. According to the writing angle or writing strength manipulated by the user, the electronic soft pen brush will generate different touch regions. Such as Chinese calligraphy brush, each of the scripts in the writing apparatus of the present invention will have a different determined display result. Besides, as shown in FIG. 3B, the electronic soft pen brush of the writing apparatus in the present invention can be replaced by human fingers. The writing apparatus in the present invention will detect the touch region, the touch area and the touch position of the human fingers according to the touch angle or the touch strength of the human fingers on the touch panel and then display on the screen of the electronic device.

Although specific embodiments have been illustrated and described, it will be appreciated by those skilled in the art that various modifications may be made without departing from the scope of the present invention, which is intended to be limited solely by the appended claims.

What is claimed is:

1. A writing apparatus with electronic soft pen brush, comprising:
an electronic soft pen brush;
a touch panel configured to generate a plurality of touch points when the electronic soft pen brush touches the touch panel;
a scanning circuit configured to detect a plurality of touch position of the touch points simultaneously; and
a controlling circuit configured to determine a touch region of the touch points in accordance with the touch positions of the touch points, and transform the touch region and the touch positions to a output signal.

2. The writing apparatus of claim 1, wherein the electronic soft pen brush includes a pen-nib and the pen-nib is soft brush or soft nib like Chinese calligraphy brush or Gouache brush.

3. The writing apparatus of claim 2, wherein the pen-nib is selected consisting of soft plastic, elastic paper fiber, thermoplastic elastomer (TPE), thermoplastic rubber (TPR) and woolens.

4. The writing apparatus of claim 1, wherein the electronic soft pen brush is replaced by human finger.

5. The writing apparatus of claim 1, wherein the touch panel is an all point addressable (APA) touch panel.

6. The writing apparatus of claim 1, wherein the touch panel is adapted on an electronic device with a display.

7. The writing apparatus of claim 6, wherein the controlling circuit transmits the output signal to the electronic device and the electronic device presents a touch image on the display.

8. A writing apparatus with electronic soft pen brush, comprising:
an electronic soft pen brush including a pen-nib;
a touch panel configured to generate a plurality of touch points when the electronic soft pen brush touches the touch panel;
a scanning circuit configured to detect a plurality of touch position of the touch points simultaneously; and
a controlling circuit configured to determine a touch region of the touch points in accordance with the touch positions of the touch points, and transform the touch region and the touch positions to a output signal;
wherein the writing apparatus generates a plurality of the touch regions with different sizes in accordance with touch angle and touch strength used by the pen-nib on the touch panel.

9. The writing apparatus of claim 8, wherein the pen-nib is soft brush or soft nib like Chinese calligraphy brush or Gouache brush.

10. The writing apparatus of claim 9, wherein the pen-nib is selected consisting of soft plastic, elastic paper fiber, thermoplastic elastomer (TPE), thermoplastic rubber (TPR) and woolens.

11. The writing apparatus of claim 8, wherein the electronic soft pen brush is replaced by human finger.

12. The writing apparatus of claim 8, wherein the touch panel is an all point addressable (APA) touch panel.

13. The writing apparatus of claim 8, wherein the touch panel is adapted on an electronic device with a display.

14. The writing apparatus of claim 13, wherein the controlling circuit transmits the output signal to the electronic device and the electronic device presents a touch image on the display.

15. An electronic device with a writing apparatus, comprising:
a writing apparatus, comprising:
an electronic soft pen brush including a pen-nib;
a touch panel configured to generate a plurality of touch points when the electronic soft pen brush touches the touch panel;
a scanning circuit configured to detect a plurality of touch position of the touch points simultaneously; and
a controlling circuit configured to determine a touch region of the touch points in accordance with the touch positions of the touch points, and transform the touch region and the touch positions to a output signal; and
a display configured to present the touch region and the touch positions on the display;
wherein the writing apparatus generates a plurality of the touch regions with different sizes in accordance with touch angle and touch strength used by the pen-nib on the touch panel.

16. The writing apparatus of claim 15, wherein the pen-nib is soft brush or soft nib like Chinese calligraphy brush or Gouache brush.

17. The writing apparatus of claim 16, wherein the pen-nib is selected consisting of soft plastic, elastic paper fiber, thermoplastic elastomer (TPE), thermoplastic rubber (TPR) and woolens.

18. The writing apparatus of claim 15, wherein the electronic soft pen brush is replaced by human finger.

19. The writing apparatus of claim 15, wherein the touch panel is an all point addressable (APA) touch panel.

20. The writing apparatus of claim 15, wherein the controlling circuit transmits the output signal to the electronic device and the electronic device presents a touch image on the display.
